(19) United States
(12) Patent Application Publication
(10) Pub. No.: US 2010/0124896 A1
(43) Pub. Date: May 20, 2010

(54) DUAL BATTERY MOBILE PHONE

(76) Inventor: Dinesh J. KUMAR, Peravallur (IN)

Correspondence Address: KYOCERA WIRELESS CORP., P.O. BOX 928289, SAN DIEGO, CA, 92192-8289, US

(21) Appl. No.: 12/275,037

(22) Filed: Nov. 20, 2008

(51) Int. Cl. H04M 1/00; H04M 11/04; H04B 1/38

(52) U.S. Cl. 455/404.1; 455/572; 455/574

(57) ABSTRACT

A cellular mobile station having at least a first battery and a second battery and a method for facilitating completion of an E911 call sequence is provided. The method comprises of ascertaining whether a power level of the first battery is below a predetermined threshold and whether the cellular mobile station is in an E911 mode, the E911 mode representing one of an attempt to call an E911 center, an E911 conversation in progress, and an emergency call back mode (ECBM) in progress. If the power level of the first battery is below the predetermined threshold and the cellular mobile station is in the E911 mode, employing power from the second battery to facilitate completion of the E911 mode.

### FIELD OF THE INVENTION

The present invention relates to mobile cellular communication devices. More particularly, the present invention relates to mobile cellular communication devices having multiple batteries.

### BACKGROUND

Cellular mobile stations, e.g., cellular phones, have long been employed for communication purposes. A mobile station can be utilized to communicate with another communication device whether the other communication device is, for example, a landline based phone or wireless phone or cellular phone.

One critical application for mobile stations is to call E911 in case of an emergency. E911 is a government-mandated service whereby a cellular service provider is required to accept an E911 call, irrespective whether the user making such an E911 call is subscribed to that particular service provider or any other service provider. By way of example, a given service provider A is required to accept an E911 call and relay the E911 call to an E911 control center even if the call originated from a mobile station that does not subscribe to the network of service provider A.

The E911 call allows the caller to be patched through to an E911 control center to relay the emergency information to a human emergency dispatcher or a computerized emergency dispatching service. Once the E911 call is completed, the mobile station would then enter into an emergency call back mode (ECBM mode) whereby the transmit/receive circuit of the mobile station would remain idle on the same frequency for 5 minutes from where the E911 call originated. The mobile station remains idle on the same frequency in order to permit location tracking by emergency personnel. Furthermore, while the mobile station is in the ECBM mode, the mobile station is inhibited from making any other calls that are not E911 in nature. While in the ECBM mode, the mobile station will also stay idle on the same frequency where the E911 call originated. Furthermore, after ending the emergency call, the mobile station will stay in the ECBM for 5 minutes. Once the 5 minutes has lapsed the mobile station would then exit the ECBM mode and return to its normal operating mode. This is, again, to facilitate the E911 tracking by emergency personnel during the ECBM period that follows the termination of the E911 call. E911 service and E911 call procedures are well known in the art and will not be discussed further here.

One of the scenarios that poses a potential danger to the user of a mobile station relates to an out-of-battery situation. When the user is making an E911 call and the battery of the mobile station runs out, the mobile phone would shut off. In this situation, in the prior art, the user can no longer make the E911 call or stay in ECBM mode. In an emergency situation, the inability to make an E911 call or to stay in the ECBM mode to permit location tracking is clearly undesirable.

### SUMMARY

The invention relates, in an embodiment, to a cellular mobile station having at least a first battery and a second battery and a method for facilitating completion of an E911 call sequence. The method comprises of ascertaining whether a power level of the first battery is below a predetermined threshold and whether the cellular mobile station is in an E911 mode, the E911 mode representing one of an attempt to call an E911 center, an E911 conversation in progress, and an emergency call back mode (ECBM) in progress. If the power level of the first battery is below the predetermined threshold and the cellular mobile station is in the E911 mode, employing power from the second battery to facilitate completion of the E911 mode.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in accordance with an embodiment of the present invention, a simplified front view of a mobile station having a logic circuitry, a mechanical switch, a LCD screen, and a LED indicator.

FIG. 2 shows, in accordance with an embodiment of the present invention, a simplified back view of a mobile station having main battery and second auxiliary battery.

FIG. 3 shows, in accordance with one or more embodiments of the invention, a flow chart of the method for maintaining an E911 call or ECBM operation if the main battery power of a mobile station is below a predetermined threshold or has been removed.

FIG. 4 shows, in accordance with one or more embodiments of the invention, a flow chart for the method for providing a user the option to activate or deactivate location tracking and/or tracing.

FIG. 5 shows, in accordance with one or more embodiments of the invention, a flow chart for facilitating or maintaining a non-E911 call if the main battery power of a mobile station is below a predetermined threshold or has been removed.

FIG. 6 shows, in accordance with one or more embodiments of the invention, a flow chart for the method of tracing the location of a mobile phone at a predetermined time and/or predetermined duration.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

Embodiments of the invention relate to methods and arrangements for permitting an E911 call to be made, an E911 call to be continued, or ECBM mode to be maintained. In an embodiment of the invention, if a user is in the middle of an E911 conversation and the mobile station's main battery power is below a predefined threshold (such as 5% or a threshold too low to permit continued conversation), logic circuitry will detect this low condition and automatically switch in the second auxiliary battery to permit the E911 call to continue.

In an embodiment, if the mobile station's main battery is too low before the initiation of the E911 call and an E911 call is attempted, logic circuitry will then switch in the second auxiliary battery to allow the E911 call to be made. In an embodiment, when the second auxiliary battery is switched in no calls except E911 calls are permitted using the second auxiliary battery. If the E911 call has already been placed and the mobile station is in an ECBM mode and the power from the main battery is exhausted during ECBM, the logic circuitry will ascertain whether the mobile station is in ECBM mode and will then automatically switch in the second auxiliary battery in order to maintain the ECBM operation.

In one or more embodiments of the invention, the second auxiliary battery may be employed to permit the continuation of location tracing. If the main battery's power is exhausted or the main battery is removed, a mechanical switch coupled to the battery or logic circuitry will switch in the second auxiliary battery and keep the transmit/receive circuit activated in order to permit location tracing by the network to which the user is subscribed.

In an embodiment, the user is provided with the ability to turn off tracing for privacy purpose. By way of example, the user may be furnished with a code which, when entered, will disable the operation of the transmit/receive circuit so that tracing is disabled for privacy purposes.

In one or more embodiments of the invention, the second auxiliary battery may be employed to permit continuation of non E911 calls. However, the mobile station will enter into a power saving mode to conserve power. During this power saving mode, the user will be alerted via either a prerecorded voice message or via message on the mobile station's LCD screen that non essential circuitry (such as power to the speaker or power to the blue tooth) will be disabled after a short time period to converse power. However, the power from the second auxiliary battery will still allow calls to be made and to be received using the transmit/receive circuit of the mobile station.

In one or more embodiments of the invention, location tracing may be facilitated using a timed tracing approach. In this embodiment, the user is provided with a preference setting to allow the user to activate and enter into the time tracing mode. In this timed tracing mode, if the main battery is low or if the main battery is removed, the mobile station will employ power from the second auxiliary battery to wake up the transmit/receive circuit to enable tracing at a predefined time and/or for a predefined duration (which may be preset at the factory or may be preset by the user using a set of preference settings).

In one or more embodiments, after the ECBM mode is exited, if there is power remaining in the second auxiliary battery, the mobile station may enter into the location tracing mode in order to allow the network to which the user subscribes to trace the location of the mobile station. In this mode, after the ECBM period ends, the transmit/receive circuit stays on to allow location tracing to continue. Location tracing following ECBM may begin immediately after the ECMB period, may begin after a predetermined delayed time period, or may be initiated at a time that is preprogrammed by the user, for example, 10 o'clock every morning. The location tracing following ECBM may continue for a predefined time such as 10 minutes or may continue until the power of the second battery is exhausted.

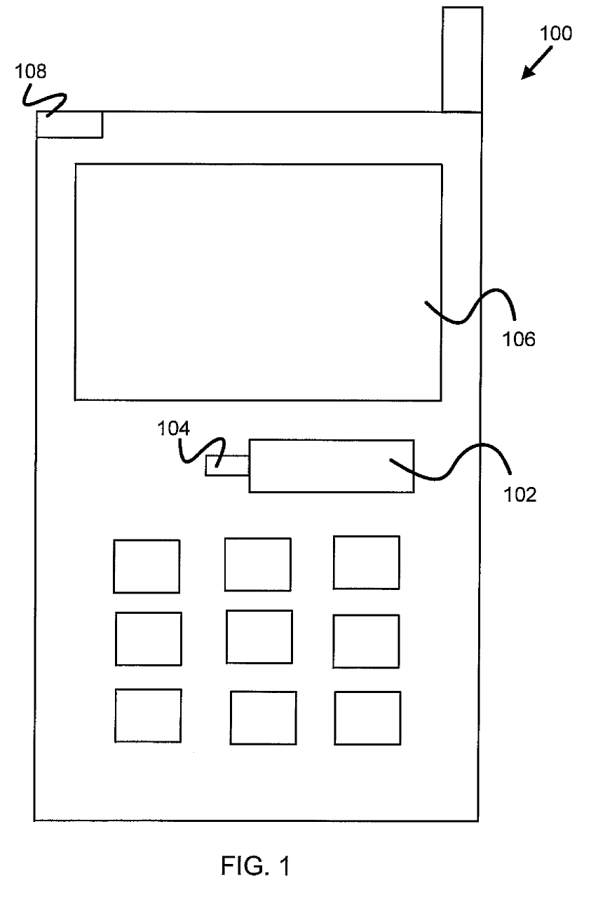

The features and advantages of the present invention may be better understood with reference to the figures and discussions that follow. FIG. 1 shows in accordance with the present invention, a simplified front view of a mobile station 100 having a logic circuitry 102, a mechanical switch 104, a LCD screen 106, and a LED indicator 108.

As mentioned earlier, if a user is on an E911 call and the main battery of the mobile station 100 falls below a predefined threshold, logic circuitry 102 will detect this low condition and automatically switch in the second auxiliary battery so the E911 call can continue. Furthermore, in an embodiment of the invention, if the mobile station's main battery is too low before the initiation of an E911 call and an E911 call is attempted, logic circuitry 102 will then switch in the second auxiliary battery to allow the E911 call to be made.

In an embodiment, if the user has already placed an E911 call and mobile station 100 is in an ECBM mode and the power from the main battery is exhausted during ECBM, logic circuitry 102 will ascertain whether the mobile station 100 is in ECBM mode and will then automatically switch in the second auxiliary battery in order to maintain the ECBM operation.

In one or more embodiments of the invention, the second auxiliary battery may be employed to permit continuation of non E911 calls. However, the mobile station 100 will enter into a power saving mode (which may be signified by some pattern of flashing of LED 108) to conserve power. During this power saving mode, the user will be alerted via either a prerecorded voice message or via message on the mobile station's LCD screen 106 that non essential circuitry will be disabled after a short time period to converse power. As can be appreciated from the forgoing, LED indicator 108 may also be employed to alert the user that the mobile station 100 is about to go into power saving mode.

Also, location tracing may be facilitated using a timed tracing approach. In this timed tracing mode, if the main battery is low or if the main battery is removed (as detected by mechanical or electromechanical switch 104 that is configured to be activated when the main battery is removed), mobile station 200 will employ power from second auxiliary battery 204 to wake up the transmit/receive circuit to enable location tracing.

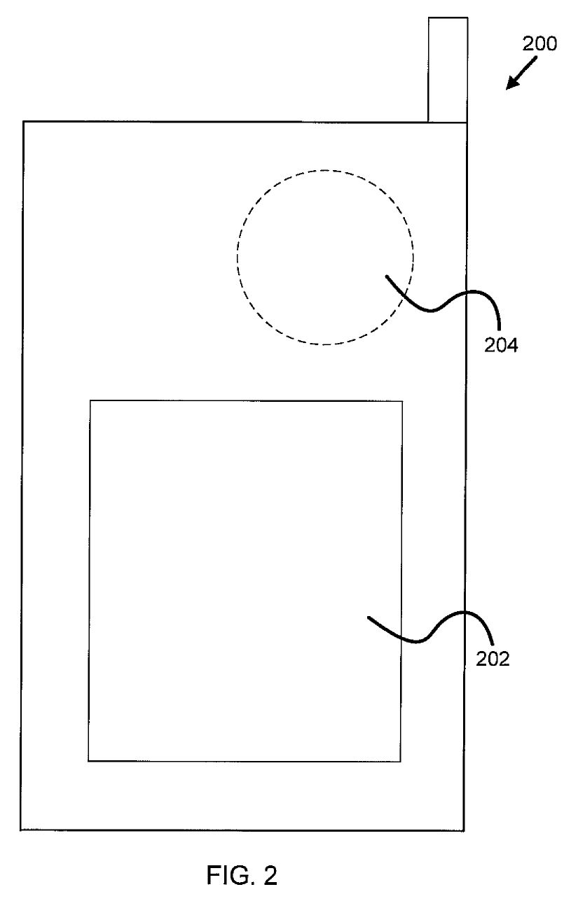

FIG. 2 shows in accordance with the present invention, a simplified back view of a mobile station 200 having main battery 202 and second auxiliary battery 204. Main battery 202 represents the battery responsible for supplying power to the mobile station for regular operation and is typically user-removable and/or user accessible. Auxiliary battery 204 may be implemented by a smaller battery (such as a coin battery) and may be designed such that auxiliary battery 204 may be inaccessible to the user to prevent unauthorized removal or disabling.

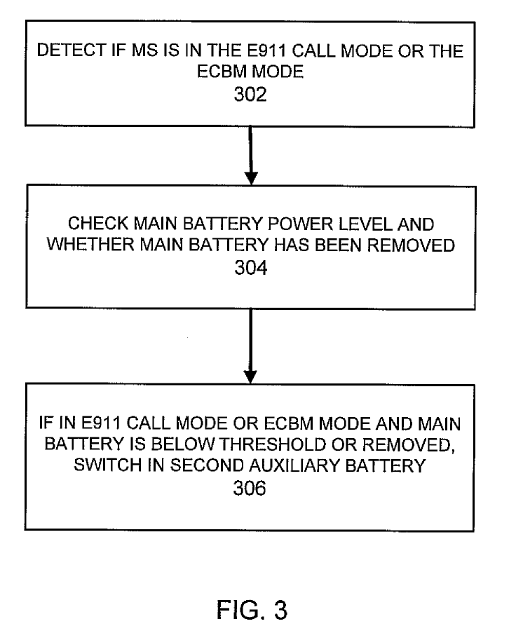

FIG. 3 shows in accordance with the present invention, a flow chart of the method for maintaining an E911 call or ECBM operation if the main battery power of a mobile station is below a predetermined threshold or has been removed.

In step 302, the logic circuitry will detect if the mobile station is in the E911 call mode or the ECBM mode. For example, the mobile station is deemed to be in the E911 call mode if the user has initiated an E911 call and is still talking to a human or automated emergency dispatcher at the E911 control center. As another example, the mobile station is deemed to be in the E911 call mode if the user is attempting to connect (by dialing 911, *911, or #911 and then press “call”, for example) to an E911 service. An example of the ECBM mode would be if the user has voluntarily or involuntarily disconnected from the E911 call and is now being tracked by the emergency control center during the ECBM interval.

In step 304, the logic circuitry checks the battery power level of the main battery and also checks to see if the battery has been removed using mechanical switch for example in order to determine if the second auxiliary battery is needed.

In step 306, if the logic circuitry has determined that the mobile station was in either the E911 call mode or ECBM mode and the main battery is below a predetermined threshold or removed, then the mobile station switches in the second auxiliary battery in order to maintain the ECBM operation or to maintain the E911 call.

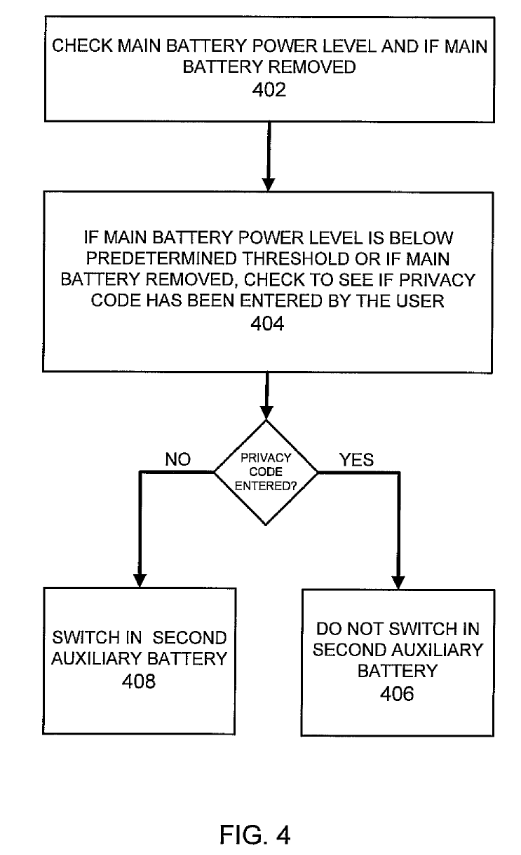

FIG. 4 shows in accordance with the present invention, a flow chart for the method for providing a user the option to activate or deactivate location tracking and/or tracing.

In step 402, the logic circuitry checks to see if the battery power level of the main battery is below a predetermined threshold level and also checks to see if the battery has been removed (e.g., via switch that is activated upon main battery removal) in order to determine if the second auxiliary battery is needed.

In step 404, if the main battery has been removed or the power level of the main battery is below a predetermined threshold, the logic circuitry would then check to see if a privacy code has been entered by the user. This privacy code can be changed by the user as per his/her requirements and is only used to enable or disable the mechanism of switching to second auxiliary battery for location tracking during non-emergency situations. However, the option of checking the privacy code is not valid if the mobile station is in ECBM mode, in an embodiment.

In step 406, if a privacy code has been entered then the mobile station would not switch in to the second auxiliary battery to enable location tracking and/or tracing. In step 408, if a privacy code has not been entered then the mobile station would then switch in to the second auxiliary battery in order to enable the location tracking and/or tracing. In an embodiment, the privacy code feature may be omitted, and the second auxiliary battery is switched in when the low power level is detected in the main battery or upon removal of the main battery to permit location tracing by the network to which the mobile station subscribes.

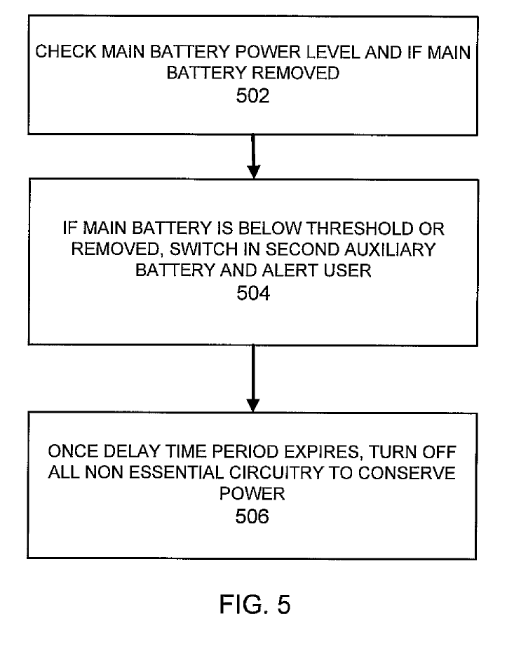

FIG. 5 shows in accordance with the present invention, a flow chart for facilitating or maintaining a non E911 call if the main battery power of a mobile station is below a predetermined threshold or has been removed.

In step 502, the logic circuitry checks to see if the battery power level of the main battery is below a predetermined threshold level and also checks to see if the battery has been removed in order to determine if the second auxiliary battery and power saving mode is needed.

If the main battery is below the predetermined threshold level or the battery has been removed, then in step 504, the mobile station will switch in to the second auxiliary battery and the user will be alerted via either a prerecorded voice message or via message on the mobile station's LCD screen that power to non essential circuitry (such as power to the speaker or power to non-essential communication circuitry such as Blue Tooth or wireless or infra-red) will be disabled after a short time period to converse power. As can be appreciated from the forgoing, LED indicator may also be employed to alert the user that the mobile station is about to go into power saving mode

In step 506, once the short time period (e.g., five seconds, 10 seconds, 20 seconds, 30 seconds, which may be predefined at the factory or user-configurable) has expired, the logic circuitry of the mobile station will then turn off all non essential circuitry in order to conserve power. However, during the power saving mode, the power from the second auxiliary battery will still allow calls to be made and to be received using the transmit/receive circuit of the mobile station.

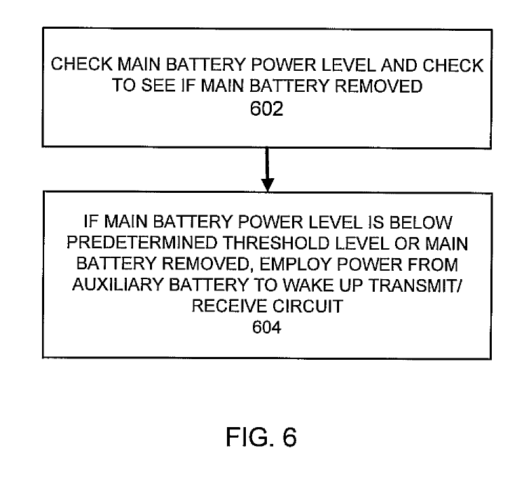

FIG. 6 shows in accordance with the present invention, a flow chart for the method of tracing the location of a mobile phone at a predetermined time and/or predetermined duration.

In step 602, the logic circuitry checks to see if the battery power level of the main battery is below a predetermined threshold level and also checks to see if the battery has been removed in order to determine if the second auxiliary battery is needed for location tracing.

If the main battery is below the predetermined threshold level or the battery has been removed, then in step 604, the mobile station will employ power from the second auxiliary battery to wake up the transmit/receive circuit to enable tracing at a predefined time and/or for a predefined duration (which may be preset at the factory or may be preset by the user using a set of preference settings).

While this invention has been described in terms of several preferred embodiments, there are alterations, permutations, and equivalents, which fall within the scope of this invention. For example, although the invention also covers circuitry, whether programmable and/or dedicated, to perform the steps described in the figures. It should be apparent to those in the art that computer-implemented software may be executed on a processor, alone or in cooperation with other circuitry, to perform the detection of a low main battery power condition, the detection of whether said mobile station is in an E911 mode, and to switch in the second battery when needed to complete the E911 mode (which includes the completion of the E911 call and any ECBM duration that follows. Alternatively or additionally, these steps and analogous steps may be performed using a set of dedicated hardware circuits and/or a set of programmable hardware circuits. The implementation of such circuits to perform the steps described herein is within the skills of those skilled in the art.

Also, the title, summary, and abstract are provided herein for convenience and should not be used to construe the scope of the claims herein. It should also be noted that there are many alternative ways of implementing the methods and apparatuses of the present invention. Although various examples are provided herein, it is intended that these examples be illustrative and not limiting with respect to the invention. Further, in this application, a set of “n” items refers zero or more items in the set. It is therefore intended that the following appended claims be interpreted as including all such alterations, permutations, and equivalents as fall within the true spirit and scope of the present invention.

What is claimed is:

1. In a cellular mobile station having at least a first battery and a second battery, a method for facilitating completion of an E911 call sequence, comprising:
ascertaining whether a power level of said first battery is below a predetermined threshold and whether said cellular mobile station is in an E911 mode, said E911 mode representing one of an attempt to call an E911 center, an E911 conversation in progress, and an emergency call back mode (ECBM) in progress;
if said power level of said first battery is below said predetermined threshold and said cellular mobile station is in said E911 mode, employing power from said second battery to facilitate completion of said E911 mode.

2. The method of claim 1 further comprising inhibiting said cellular mobile station from making or receiving non-E911 calls after said completion of said E911 mode if said power level of said first battery remains below said predetermined threshold.

3. The method of claim 1 wherein said E911 mode represents said attempt to call said E911 center.

4. The method of claim 1 wherein said E911 mode represents said E911 conversation in progress.

5. The method of claim 1 wherein said E911 mode represents said ECBM in progress.

6. The method of claim 1 further comprising permitting non-E911 calls to be made or received during a reduced power consumption mode after said completion of said E911 mode, said reduced power consumption includes turning off nonessential circuitry in said cellular mobile station.

7. The method of claim 1 wherein said turning off nonessential circuitry including turning off a LCD (liquid crystal display) screen of said cellular mobile station.

8. In a cellular mobile station having at least a first battery and a second battery, a method for facilitating location tracing of said cellular mobile station, comprising:
ascertaining whether said cellular mobile station is in a first state, said first state representing one of a power level of said first battery being below a predetermined threshold and said first battery removed; and
if said cellular mobile station is in said first state, employing power from a second battery to activate transmit/receive circuitry of said cellular mobile station at a predetermined time to facilitate said location tracing by a cellular network to which said cellular mobile station subscribes.

9. The method of claim 8 wherein said first state representing said power level of said first battery being below said predetermined threshold.

10. The method of claim 8 wherein said first state representing said first battering removed.

11. The method of claim 8 wherein said employing power from said second battery to activate said transmit/receive circuitry of said cellular mobile station at said predetermined time includes activating said transmit/receive circuitry only for a predetermined duration.

12. The method of claim 8 wherein said employing power from said second battery to activate said transmit/receive circuitry of said cellular mobile station at said predetermined time includes keeping said transmit/receive circuitry activated until said second battery is exhausted.

13. The method of claim 8 wherein said employing power from said second battery to activate said transmit/receive circuitry of said cellular mobile station at said predetermined time only occurs if said cellular mobile station is also not in a privacy mode, said privacy mode inhibiting said transmit/receive circuit from being activated to facilitate said location tracing even if said cellular mobile station is in said first state.

14. The method of claim 8 wherein said privacy mode is activated by an entry of a privacy code by a user of said cellular mobile station.

15. In a cellular mobile station having at least a first battery and a second battery, a method for facilitating a cellular call, comprising:
ascertaining whether said cellular mobile station is in a first state, said first state representing one of a power level of said first battery being below a predetermined threshold and said first battery removed; and
if said cellular mobile station is in said first state, employing power from a second battery to power transmit/receive circuitry of said cellular mobile station while enforcing a turnoff of a set of circuitries that are nonessential for said facilitating said cellular call.

16. The method of claim 15 wherein said first state representing said power level of said first battery being below said predetermined threshold.

17. The method of claim 15 wherein said first state representing said first battering removed.

18. The method of claim 15 wherein said set of circuitries that are nonessential for said facilitating said cellular call includes at least one of a liquid crystal display (LCD) screen and a speaker phone of said cellular mobile station.

19. The method of claim 15 wherein said set of circuitries that are nonessential for said facilitating said cellular call includes a wireless circuit configured for communicating with peripheral devices.

20. The method of claim 15 further including providing a warning message to a user of said cellular mobile station that said set of circuitries that are nonessential to said facilitating said cellular call would be turned off after a predetermined time duration prior to said enforcing said turnoff of said set of circuitries.
